(19) United States
(12) Patent Application Publication
(10) Pub. No.: US 2022/0348041 A1
(43) Pub. Date: Nov. 3, 2022

(54) Tire Comprising a Tread

(71) Applicant: COMPAGNIE GENERALE DES ETABLISSEMENTS MICHELIN, Clermont-Ferrand (FR)

(72) Inventors: Frederic BOURGEOIS, Clermont-Ferrand Cedex 9 (FR); Benoit DURAND-GASSELIN, Clermont-Ferrand Cedex 9 (FR); Olivier MUHLHOFF, Clermont-Ferrand Cedex 9 (FR)

(21) Appl. No.: 17/623,996

(22) PCT Filed: Jul. 2, 2020
(86) PCT No.: PCT/FR2020/051163

§ 371 Date: Dec. 30, 2021

(30) Foreign Application Priority Data
Jul. 2, 2019 (FR) FR1907322

(51) Int. Cl. B60C 11/12; B60C 11/03

(52) U.S. Cl. CPC B60C 11/1236; B60C 11/0306

(57) ABSTRACT

A tire with a tread (10) having at least one series (12) of rubber blocks (13ᵢ₋₁, 13ᵢ, 13ᵢ₊₁, 13ᵢ₊₂) delimited pairwise by a series of sipes (14ᵢ₋₁,14ᵢ, 14ᵢ₊₁,14ᵢ₊₂,14ᵢ₊₃), with the blocks (13ᵢ₋₁, 13ᵢ, 13ᵢ₊₁, 13ᵢ₊₂) extending one after another in a circumferential direction (X), each block (13₁₋₁, 13ᵢ, 13ᵢ₊₁, 13ᵢ₊₂) of the series (12) of rubber blocks having a circumferential length (Lᵢ₋₁, Lᵢ, Lᵢ₊₁, Lᵢ₊₂)), each sipe (14ᵢ₋₁,14ᵢ, 14ᵢ₊₁, 14ᵢ₊₂,14₁₊₃) having a circumferential width (Eᵢ₋₁, Eᵢ,Eᵢ₊₁, Eᵢ₊₂, Eᵢ₊₃). The series (12) of rubber blocks have blocks belonging to at least two different classes of blocks ((13ᵢ₋₁13ᵢ); (13ᵢ₊₁, 13ᵢ₊₂)), the blocks of the one same class having a substantially identical circumferential length, the blocks of two different classes of blocks having distinct circumferential lengths.

### TECHNICAL FIELD

The present invention relates to a tire for a motor vehicle, of which tire the tread comprises at least one series of rubber blocks separated pairwise by grooves and extending one after another in a circumferential direction.

### PRIOR ART

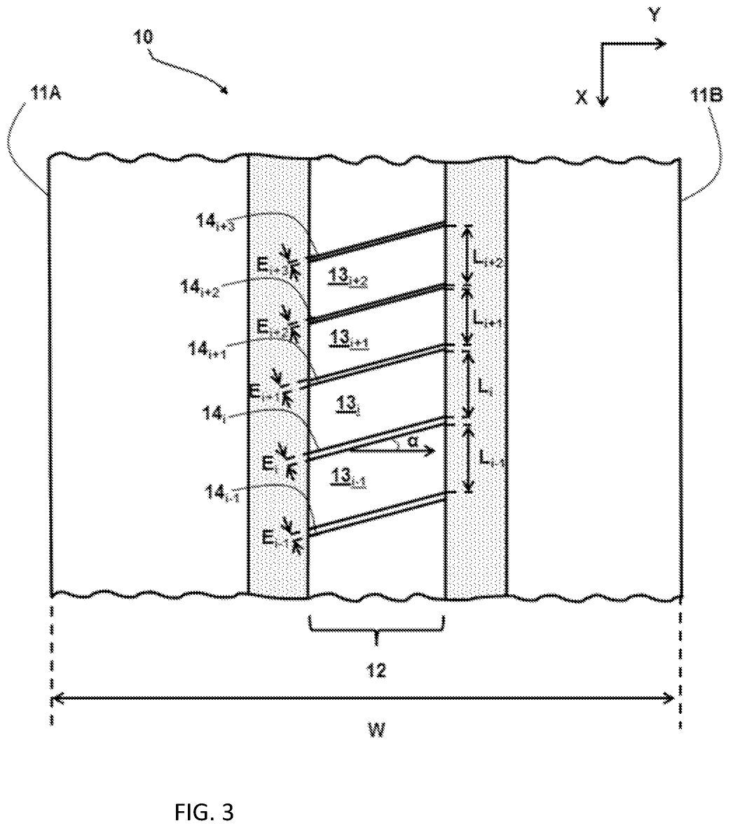

In a known manner, a tire intended to be fitted to a motor vehicle has a tread. This tread comprises a tread surface and two edges delimiting said tread surface. The tread surface corresponds to all of the points of the tread that come into contact with a road surface when the tire, inflated to its reference pressure and compressed by a reference load, is running on this road surface. The reference inflation pressure and the reference load are defined in the use conditions of the tire, which conditions are specified in particular by the E.T.R.T.O. standard. In document WO2018185436, FIG. 3 illustrates a tread comprising a plurality of rubber blocks. The rubber blocks are organized as ribs of rubber, each rubber rib comprising a plurality of rubber blocks which extend one after another in a circumferential direction. More particularly, FIG. 3 of document WO2018185436 discloses a tread comprising a set of five rubber ribs. This set of rubber ribs comprises two edge rubber ribs arranged respectively at each of the two edges of the tread, a rubber rib central to the tread and two intermediate rubber ribs positioned between the central rubber rib and the edge rubber ribs.

In order to limit the emergence of tire noise during running, document US3989780 teaches the use, within the one same rib, of rubber blocks having different lengths in the circumferential direction. Such tire noise is notably caused by movements of the rubber blocks which vibrate upon impact with the surface of the ground, creating impulses of audio frequencies in suspension in the air and vibrations of the vehicle. It is the interaction between all the impulses that creates this tire noise. Combining rubber blocks of different sizes allows the tire noise to be modulated, at least in part. However, the use of rubber ribs comprising blocks of different sizes may, during running, generate a pronounced difference in wear between different parts of the tread.

There is therefore a need to obtain a tire having optimized acoustic performance but at the same time having a roughly uniform wear rate.

### SUMMARY OF THE INVENTION

The present invention aims to remedy this drawback.

More specifically, the present invention seeks to improve the acoustic performance of a tire while at the same time improving the wearing performance thereof.

The invention relates to a tire comprising a tread comprising at least one series of rubber blocks delimited pairwise by a series of sipes. The blocks extend one after another in a circumferential direction. In this circumferential direction, each block of the series of rubber blocks has a circumferential length and each sipe has a circumferential width.

A “tire” means all types of tire casing made of a rubbery material and which, during running, is subjected to an internal pressure or not subjected to such an internal pressure during running (which is the case of an airless tire, for example of the Tweel™ type).

A “rubbery material” means a rubber compound containing a diene elastomer, that is to say, in a known way, an elastomer which is at least partially based on (i.e. is a homopolymer or copolymer of) diene monomers (monomers bearing conjugated or non-conjugated carbon-carbon double bonds).

The “tread” of a tire means a quantity of rubbery material delimited by a tread surface. The tread surface groups together all the points of the tire that will come into contact with the ground under normal running conditions. For a tire, the “normal running conditions” are the use conditions defined by the ETRTO (European Tire and Rim Technical Organisation) standard. These use conditions specify the reference inflation pressure corresponding to the load-bearing capacity of the tire as indicated by its load index and its speed rating. These use conditions can also be referred to as “nominal conditions” or “working conditions”.

A “block” means a raised element delimited by sipes, in a circumferential direction, and comprising lateral walls and a contact face, the latter being intended to come into contact with a road surface during running.

A “groove” means an incision of which the walls of material are separated by a distance greater than 2 mm.

A “sipe” means an incision of which the walls of material are separated by a distance at most equal to 2 mm. The depth of a sipe in the tread is greater than or equal to 1 mm.

The “circumferential width of the sipe” means the distance measured between the walls of material of said sipe. This distance is measured at a depth of 2 mm from the tread surface, inside the sipe and in the middle of this sipe.

The “circumferential length of the block” means the distance measured between two sipes that delimit a block in the circumferential direction. The distance is measured in the middle of this block.

A “circumferential direction” means a direction tangential to any circle centred on the axis of rotation of the tire. This direction is perpendicular both to an axial direction and to a radial direction.

An “axial direction” means a direction parallel to the axis of rotation of the tire.

A “radial direction” means a direction which is perpendicular to the axis of rotation of the tire (this direction corresponds to the direction of the thickness of the tread).

The series of blocks comprises blocks belonging to at least two different classes of blocks. The blocks of the one same class have a substantially identical circumferential length, and the blocks of two different classes of blocks have distinct circumferential lengths. The series of sipes comprises sipes belonging to at least two different classes of sipes, the sipes of the one same class of sipes having a substantially identical circumferential width, the sipes of two different classes of sipes having distinct circumferential widths. The blocks belonging to the class of blocks of smallest circumferential length are delimited, at least in part, by sipes belonging to the class of sipes of smallest circumferential width, and the blocks belonging to the class of blocks of greatest circumferential length are delimited, at least in part, by sipes belonging to the class of sipes of greatest circumferential width.

The sipes and the rubber blocks can thus be grouped together respectively by class of sipes or class of rubber blocks according to their dimensions (circumferential length, circumferential width). Sipes are considered to belong to the one same class of sipes even if their circumferential width differs significantly. However, this difference should be minimal. Thus it is considered that, at most, the difference in circumferential width between the sipe of greatest circumferential width of the class of sipes and the sipe of smallest circumferential width of said class of sipes is at most equal to 10% of the circumferential width of the sipe of greatest circumferential width of said class of sipes. Likewise, blocks are considered to belong to the one same class of blocks even if their circumferential length differs significantly. However, this difference should be minimal. Thus it is considered that, at most, the difference in circumferential length between the block of greatest circumferential length of the class of blocks and the block of smallest circumferential length of said class of blocks is at most equal to 10% of the circumferential length of the block of greatest circumferential length of said class of blocks.

It is a well-known fact that the sipes are moulded by mould elements. More particularly, during the moulding of the tread of the tire, the mould elements penetrate the raw tire in order to mould said sipes therein. During this operation, the mould elements apply pressure to part of the raw rubber which will then flow towards the mould cavities intended for moulding the rubber blocks. If the sipe that is to be moulded is wide, a large quantity of raw rubber flows into a mould cavity intended for moulding an adjacent block, and pressure is therefore applied to part of the architecture of the tire in line with the mould cavity. This “rubber surplus” phenomenon is all the more prevalent when the block that is to be moulded is of a class of blocks typified by a small circumferential length. Once cured, the tire is released from the mould and that part of the architecture that had been prestressed by the surplus of raw rubber repositions itself with the tendency to offset radially outwards the rubber block moulded in the tread. As a result, there is a lack of uniformity in this tread and this lack of uniformity may ultimately lead to differential wearing of certain parts of the tread during successive running.

Likewise, if the sipe that is to be moulded is not very wide in the circumferential direction, a small quantity of rubber flows into the mould cavity intended to mould an adjacent block, and it may therefore be that this cavity is not correctly filled with rubber, leading to nonconformity of the tire once it has been demoulded. This “rubber deficit” phenomenon is all the more prevalent when the block that is to be moulded is of a class of blocks typified by a great circumferential length. By proposing to associate with each rubber block a sipe the class of which corresponds to that of the block concerned, the moulding of the block during the moulding operation becomes easier and the external appearance of the tire once it has been demoulded and, therefore, the wearing performance of this tire, are improved.

In one preferred embodiment, blocks belonging to the class of blocks of smallest circumferential length Cbₘᵢₙ are delimited by two sipes belonging to the class of sipes of smallest circumferential width Csₘᵢₙ and/or blocks belonging to the class of blocks of greatest circumferential length Cbₘₐₓ are delimited by two sipes belonging to the class of sipes of greatest circumferential width CSₘₐₓ.

In one preferred embodiment, the number of classes of blocks is less than 5 and preferably equal to 3.

In one preferred embodiment, the number of classes of sipes is less than 5 and preferably equal to 3.

In one preferred embodiment, a first ratio R1 corresponds to the ratio between the circumferential width of a sipe belonging to the class of sipes of smallest circumferential width Csₘᵢₙ to the circumferential length of a block belonging to the class of blocks of smallest circumferential length Cbₘᵢₙ and a second ratio R2 corresponds to the ratio between the circumferential width of a sipe belonging to the class of sipes of greatest circumferential width Csₘₐₓ to the circumferential length of a block belonging to the class of blocks of greatest circumferential length Cbₘₐₓ. The first ratio R1 and the second ratio R2 are determined in such a way that the ratio of said first ratio R1 to said second ratio R2 is at least equal to 0.9 and at most equal to 1.1.

In one preferred embodiment, the ratio between the circumferential length of a block belonging to the class of blocks of greatest circumferential length Cbₘₐₓ to the circumferential length of a block belonging to the class of blocks of smallest circumferential length Cbₘᵢₙ is at least equal to 1.2 and at most equal to 2. As a preference, this ratio is at least equal to 1.4 and at most equal to 1.75.

In a preferred embodiment variant, the tread comprises a tread surface and the sipes form lines on said tread surface, said lines being linear and inclined with respect to an axial direction by an angle of inclination a, said angle of inclination α being at least equal to 5 degrees and at most equal to 60 degrees or the sipes form lines on said tread surface, said lines being curved.

In one preferred embodiment, the tread is delimited by two edges and the series of rubber blocks is positioned near to one of said edges of said tread.

The present invention will be understood better upon reading the detailed description of embodiments that are given by way of entirely non-limiting examples and are illustrated by the appended drawings, in which:

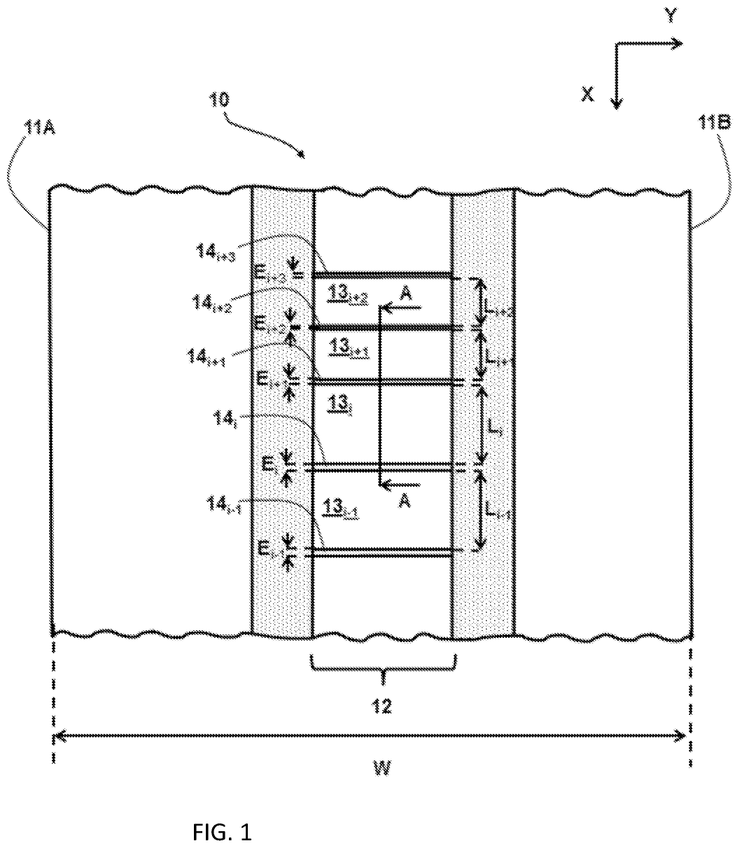

FIG. 1 is a schematic view showing part of a tread of a tire according to a first embodiment of the invention;

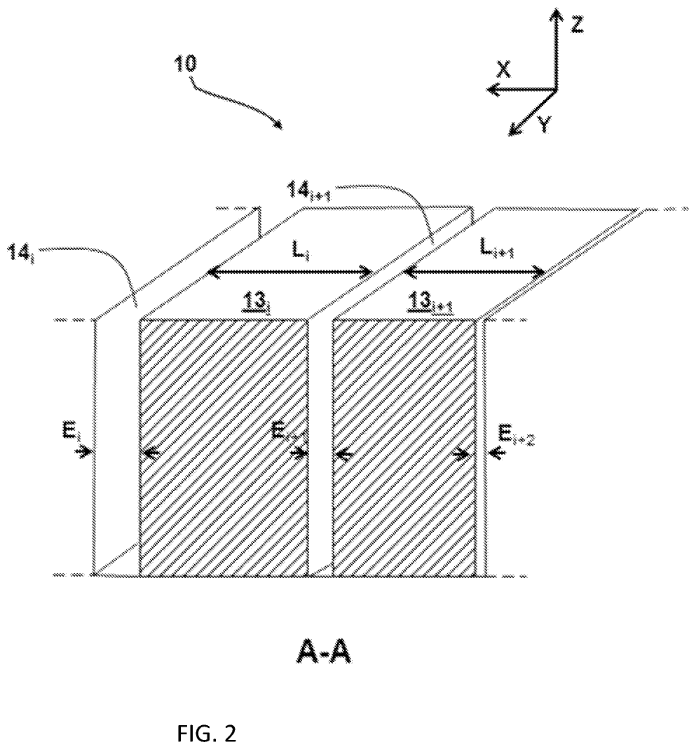

FIG. 2 is a view in section on A-A of FIG. 1;

FIG. 3 is a schematic view showing part of a tread of a tire according to a second embodiment of the invention.

In the various figures, identical or similar elements bear the same references.

FIG. 1 is a schematic view showing part of a tread 10 of a tire according to a first embodiment of the invention. FIG. 2 is a view in section on A-A of FIG. 1. The tread 10 is delimited axially by two edges 11A and 11 B. These two edges 11A, 11B determine the width W of the tread 10. Beyond these two edges 11A, 11B extend the two sidewalls of the tire.

The tread 10 is delimited radially by a surface of the tread. This tread surface groups together all the points of the tire that will come into contact with the ground under normal running conditions. More specifically, the tread 10 comprises n rubber blocks of which only some of these blocks 13ᵢ₋₁, 13ᵢ, 13ᵢ₊₁, 13ᵢ₊₂ are referenced in FIG. 1. These rubber blocks are organized as a series 12 of rubber blocks which extend one after another in a circumferential direction. This series 12 of blocks therefore forms a rubber rib. This rubber rib here extends along the entire circumference of the tire. In the embodiment of FIG. 1, the series 12 of rubber blocks 13ᵢ₋₁, 13ᵢ, 13ᵢ₊₁, 13ᵢ₊₂ extends in the central part of the tread 12. As a variant, the series 12 of rubber blocks 13ᵢ₋₁, 13ᵢ, 13ᵢ₊₁, 13ᵢ₊₂ is offset with respect to this central part. For example, the series 12 of rubber blocks is positioned near one of said edges 11A, 11B of the tread 10.

The rubber blocks 13ᵢ₋₁, 13ᵢ, 13ᵢ₊₁, 13ᵢ₊₂ are delimited pairwise by a series of sipes 14ᵢ₋₁,14ᵢ, 14ᵢ₊₁, 14ᵢ₊₂. These sipes determine a circumferential length Lᵢ₋₁, Lᵢ,Lᵢ₊₁, Lᵢ₊₂ for each block 13ᵢ₋₁, 13ᵢ, 13iᵢ₊₁, 13ᵢ₊₂. Certain circumferential block-lengths are substantially identical. It is therefore possible to classify the blocks 13ᵢ₋₁, 13ᵢ, 13ᵢ₊₁, 13ᵢ₊₂ into at least two different classes of blocks. The blocks of the one same class have a substantially identical circumferential length, and the blocks of two different classes of blocks have distinct circumferential lengths. Thus, in the embodiment of FIGS. 1 and 2, the blocks 13ᵢ₋₁, 13ᵢ can be associated within the one same first class of blocks as the length of the block 13ᵢ₋₁ is substantially identical to the length Lᵢ of the block 13ᵢ. Likewise, the blocks 13ᵢ₊₁, 13ᵢ₊₂ can be associated within the one same second class of blocks as the length Lᵢ₊₁ of the block 13ᵢ₊₁ is substantially identical to the length Lᵢ₊₂ of the block 13ᵢ₊₂. The blocks belonging to the first class of blocks here have a greater circumferential length than the blocks belonging to the second class of blocks. The first class of blocks will be referred to hereinafter as Cbmax and the second class of blocks will also be referred to hereinafter as Cb_{min.}

As has already been specified, the rubber blocks 13ᵢ₋₁, 13ᵢ, 13ᵢ₊₁,13ᵢ₊₂ are delimited by a series of sipes 14ᵢ₋₁,14ᵢ, 14ᵢ₊₂,14ᵢ₊₃. Each sipe 14ᵢ₋₁,14ᵢ, 14ᵢ₊₁, 14ᵢ₊₂,14ᵢ₊₃ has a circumferential width Eᵢ₋₁, Eᵢ,Eᵢ₊₁, Eᵢ₊₂, Eᵢ₊₃. Certain circumferential sipe-widths are substantially identical. It is therefore possible to classify the sipes 14ᵢ₋₁, 14ᵢ, 14ᵢ₊₁, 14₁₊₂, 14ᵢ₊₃ into at least two different classes of sipes. The sipes of the one same class have a substantially identical circumferential width, and the sipes of two different classes have distinct circumferential widths. Thus, in the embodiment of FIGS. 1 and 2, the sipes 14ᵢ₋₁, 14ᵢ, can be associated within the one same first class of sipes as the circumferential width Eᵢ₋₁ of the sipe is substantially identical to the circumferential width Eᵢ of the sipe 14ᵢ. Likewise, the sipes 14ᵢ₊₂, 14ᵢ₊₃ can be associated within the one same second class of sipes as the circumferential width Eᵢ₊₂ of the sipe 14ᵢ₊₂ is substantially identical to the circumferential width Eᵢ₊₃ of the sipe 14ᵢ₊₃. A third class of sipes here comprises the sipe 14ᵢ₊₁ of circumferential width Eᵢ₊₁. The sipes 14ᵢ₋₁, 14ᵢ belonging to the first class of sipes here have a greater circumferential width than the sipes 14ᵢ₊₂, 14₊₃ belonging to the second class of sipes and than the sipe 14ᵢ₊₁ belonging to the third class of sipes. The sipe belonging to the third class of sipes has a greater circumferential width than the sipes belonging to the second class of sipes. The first class of sipes will be referred to hereinafter as Csₘₐₓ and the second class of sipes will also be referred to hereinafter as Csₘᵢₙ. The blocks 13ᵢ₋₁, 13ᵢ, 13ᵢ₊₁, 13ᵢ₊₂ and the sipes 14ᵢ₋₁,14ᵢ, 14ᵢ₊₂,14ᵢ₊₃ are organized in such a way that the blocks 13ᵢ₊₁, 13ᵢ₊₂ belonging to the class of blocks of smallest circumferential length Cbₘᵢₙ are delimited, at least in part, by sipes 14ᵢ₊₂, 14ᵢ₊₃ belonging to the class of sipes of smallest circumferential width Csₘᵢₙ and the blocks 13ᵢ₋₁, 13ᵢ belonging to the class of blocks of greatest circumferential length Cbₘₐₓ are delimited, at least in part, by sipes 14ᵢ₋₁,14ᵢ belonging to the class of sipes of greatest circumferential width Csₘₐₓ. More specifically, in the embodiment of FIGS. 1 and 2, the block 13ᵢ₊₂ belonging to the class of blocks of smallest circumferential length Cbₘᵢₙ is delimited by two sipes 14ᵢ₊₂, 14ᵢ₊₃ belonging to the class of sipes of smallest circumferential width Csₘᵢₙ and the block 13ᵢ₋₁ belonging to the class of blocks of greatest circumferential length Cbₘₐₓ is delimited by two sipes 14ᵢ₋₁,14ᵢ belonging to the class of sipes of greatest circumferential width Cs_{max.}

Within the one same class of sipes, the circumferential width of the sipes may differ significantly. However, this difference is minimal. Thus it is considered that, at most, the difference in circumferential width between the sipe of greatest circumferential width of the class of sipes and the sipe of smallest circumferential width of said class of sipes is at most equal to 0.1 mm. Likewise, blocks are considered to belong to the one same class of blocks even if their circumferential length differs significantly. However, this difference should be minimal. Thus it is considered that, at most, the difference in circumferential length between the block of greatest circumferential length of the class of blocks and the block of smallest circumferential length of said class of blocks is at most equal to 0.1 mm.

Furthermore, it is possible to determine a first ratio R1 corresponding to the ratio between the circumferential width Eᵢ₊₂, Eᵢ₊₃ of a sipe 14ᵢ₊₂, 14ᵢ₊₃ belonging to the class of sipes of smallest circumferential width Csₘᵢₙ to the circumferential length Lᵢ₊₁, Lᵢ₊₂ of a block 13ᵢ₊ᵢ, 13ᵢ₊₂ belonging to the class of blocks of smallest circumferential length Cbₘᵢₙ. It is also possible to determine a second ratio R2 corresponding to the ratio between the circumferential width Eᵢ₋₁, Eᵢ of a sipe 14ᵢ₋₁, 14ᵢ belonging to the class of sipes of greatest circumferential width Csₘₐₓ to the circumferential length Lᵢ₋₁, Lᵢ of a block 13ᵢ₋₁, 13ᵢ belonging to the class of blocks of greatest circumferential length Cbₘₐₓ. The first ratio R1 and the second ratio R2 are determined in such a way that the ratio of said first ratio R1 to said second ratio R2 is greater than or equal to 0.9 and less than or equal to 1.1.

In addition, the ratio between the circumferential length , Lᵢ₋₁, Lᵢ of a block belonging to the class of blocks of greatest circumferential length Cbₘₐₓ to the circumferential length Lᵢ₊₁, Lᵢ₊₂ of a block 13ᵢ₊₁,13ᵢ₊₂ belonging to the class of blocks of smallest circumferential length Cbₘᵢₙ is at least equal to 1.2 and at most equal to 2. As a preference, this ratio is comprised between 1.4 and 1.75.

Finally, in the embodiment of FIGS. 1 and 2, the sipes 14ᵢ₋₁,14ᵢ, 14ᵢ₊₁, 14ᵢ₊₂,14ᵢ₊₃ form linear lines on the tread surface of the tread 10. These lines here are oriented in an axial direction Y.

In the embodiment of FIG. 3, the sipes 14ᵢ₋₁,14ᵢ, 14ᵢ₊₁, 14ᵢ₊₂, 14iᵢ₊₃ form linear lines which are inclined with respect to the axial direction Y. It will now be noted that the foregoing description of the blocks 13ᵢ₋₁, 13ᵢ, 13ᵢ₊₁, 13ᵢ₊₂ and of the sipes 14ᵢ₋₁,14ᵢ, 14ᵢ₊₁, 14ᵢ₊₂, 14ᵢ₊₃ and their arrangement in the tread applies mutatis mutandis to the embodiment of FIG. 3. The lines here are inclined by an angle of inclination α. This angle of inclination α is at least equal to 5 degrees and at most equal to 60 degrees. As a preference, this angle of inclination is at least equal to 30 degrees and at most equal to 50 degrees.

In an embodiment which has not been depicted, the sipes form curved lines on the tread surface of the tread 10.

In the embodiments of FIG. 1 and of FIG. 3, the number of classes of sipes is equal to 3. As a variant, this number of classes of sipes is less than or equal to 5. For example, the number of classes of sipes is equal to 4. In such a case, the sipes of the classes of sipes may have the following circumferential-width values: 0.8 mm, 1 mm, 1.2 mm, 1.5 mm. As has already been specified, within the one same class of sipes the circumferential-width values may differ significantly. Thus, the 0.8-mm class of sipes may group together sipes with circumferential-width values comprised between 0.75 mm and 0.85 mm. Likewise, the 1-mm class of sipes may group together sipes with circumferential-width values comprised between 0.95 mm and 1.05 mm. The 1.2-mm class of sipes may group together sipes with circumferential-width values comprised between 1.15 mm and 1.25 mm, and finally, the 1.5-mm class of sipes may group together sipes with circumferential-width values comprised between 1.45 mm and 1.55 mm.

In the embodiments of FIG. 1 and of FIG. 3, the number of classes of blocks is equal to 2. As a variant, the number of classes of blocks is less than or equal to 5. As a preference, this number of classes of blocks is equal to 3. In such a case, the blocks may have the following circumferential-length values: 17.9 mm, 21.2 mm, 25.8 mm. As has already been specified, within the one same class of blocks the circumferential-length values may differ significantly. Thus, the 17.9-mm class of blocks may group together blocks with circumferential-length values comprised between 17.4 mm and 18.4 mm. Likewise, the 21.2-mm class of blocks may group together blocks with circumferential-length values comprised between 20.7 mm and 21.7 mm, and finally, the 25.8-mm class of blocks may group together blocks with circumferential-length values comprised between 25.3 mm and 26.3 mm.

1. A tire comprising a tread, said tread comprising at least one series of rubber blocks delimited pairwise by a series of sipes, said blocks extending one after another in a circumferential direction (X), each block of the series of rubber blocks having a circumferential length, each sipe having a circumferential width wherein the series of rubber blocks comprises blocks belonging to at least two different classes of blocks, the blocks of the one same class having a substantially identical circumferential length, the blocks of two different classes of blocks having distinct circumferential lengths, and wherein the series of sipes comprises sipes belonging to at least two different classes of sipes, the sipes of the one same class of sipes having a substantially identical circumferential width, the sipes of two different classes of sipes having distinct circumferential widths, and wherein the blocks belonging to the class of blocks of smallest circumferential length Cbₘᵢₙ are delimited, at least in part, by sipes belonging to the class of sipes of smallest circumferential width Csₘᵢₙ and wherein the blocks belonging to the class of blocks of greatest circumferential length Cbₘₐₓ are delimited, at least in part, by sipes belonging to the class of sipes of greatest circumferential width Csₘₐₓ. 2. The tire according to Claim 1, wherein blocks belonging to the class of blocks of smallest circumferential length Cbₘᵢₙ are delimited by two sipes belonging to the class of sipes of smallest circumferential width CSₘᵢₙ and/or blocks belonging to the class of blocks of greatest circumferential length Cbₘₐₓ are delimited by two sipes belonging to the class of sipes of greatest circumferential width CSₘₐₓ. 3. The tire according to Claim 1, wherein the number of classes of blocks is less than or equal to 5. 4. The tire according to Claim 1, wherein the number of classes of sipes is less than or equal to 5.

5. The tire according to Claim 1, wherein a first ratio R1 corresponding to the ratio between the circumferential width of a sipe belonging to the class of sipes of smallest circumferential width Csₘᵢₙ to the circumferential length of a block belonging to the class of blocks of smallest circumferential length Cbₘᵢₙ and a second ratio R2 corresponding to the ratio between the circumferential width of a sipe belonging to the class of sipes of greatest circumferential width Csₘₐₓ to the circumferential length of a block belonging to the class of blocks of greatest circumferential length Cbₘₐₓ, wherein the first ratio R1 and the second ratio R2 are determined in such a way that the ratio of said first ratio R1 to said second ratio R2 is at least equal to 0.9 and at most equal to 1.1.

6. The tire according to Claim 1, wherein the ratio between the circumferential length of a block belonging to the class of blocks of greatest circumferential length Cbₘₐₓ to the circumferential length of a block belonging to the class of blocks of smallest circumferential length Cbₘᵢₙ is at least equal to 1.2 and at most equal to 2.

7. The tire according to Claim 1, wherein the tread comprises a tread surface, wherein the sipes form lines on said tread surface, said lines being linear and inclined with respect to an axial direction (Y) by an angle of inclination α, said angle of inclination a being at least equal to 5 degrees and at most equal to 60 degrees or the sipes form lines on said tread surface, said lines being curved.

8. The tire according to Claim 1, wherein the tread is delimited by two edges, and wherein the series of rubber blocks is positioned near to one of said edges of the tread.

9. The tire according to Claim 2, wherein the number of classes of blocks is less than or equal to 5.

10. The tire according to claim 3, wherein the number of classes of sipes is less than or equal to 5.

11. The tire according to claim 1, wherein the number of classes of blocks is less than or equal to 3.

12. The tire according to claim 1, wherein the number of classes of sipes is less than or equal to 3.
